(19) United States
(12) Patent Application Publication
(10) Pub. No.: US 2002/0032602 A1
(43) Pub. Date: Mar. 14, 2002

(54) Recipient selection and message delivery system and method

(76) Inventors: Kenneth F. Lanzillo JR., Stratham, NH (US); David A. Schrier, Exeter, NH (US)

Correspondence Address: David D. Lowry, Brown Rudnick Freed & Gesmer, Box IP, One Financial Center, 18th Floor, Boston, MA, 02111, US

(21) Appl. No.: 09/771,773

(22) Filed: Jan. 29, 2001

Related U.S. Application Data
(60) Provisional application No. 60/178,977, filed on Jan. 28, 2000.

(51) Int. Cl. G06F 17/60

(52) U.S. Cl. 705/14

(57) ABSTRACT

A system and method for distribution targeted advertisements over a communication network such as by email to a set of users or subscribers. The system includes a database of demographic information on the users, and an order processing component which receives and processes demographic queries, to determine a set of users in the database which match the query. An email service provider sends the targeted advertisements out to each user and an accounting component, receives information regarding the users' receipt of the targeted advertisement. The system is highly scalable and fault tolerant due to features such as distributed processing and system logging. The system also allows interactive querying of the database to determine demographic queries and sets of users who match each query. Therefore the system and method provides efficient distribution and tracking of targeted advertising

### RELATED APPLICATION

This patent application claims priority to U.S. Provisional Application Serial No. 60/178,977 filed Jan. 28, 2000 by Schrier et al., which is hereby incorporated by reference.

### FIELD OF INVENTION

The present invention relates to efficient distribution and tracking of targeted advertising.

### BACKGROUND

The community of users of public wide-area networks, such as the Internet and America Online, has grown to become a tempting target for online advertisers. In the past, advertisers have placed online ads with the content-providers whose web-pages are considered likely to attract the attention of users at least mildly interested in the products and services being advertised. These are called “banner ads.” For example, a sporting-goods ad might be placed on the web-pages of a sports team, or on selected student-activities pages at a university or certain yellow pages or search results, in an attempt to attract business. Users having web browsers on their workstations or personal computers (PCs) then contact a web-site for information, and receive the extra information comprising the banner advertisement, whether they wanted it or not.

The underlying assumption is that some number of users will notice the ad, become interested in it, and take steps to obtain more information, such as clicking on the banner ad image itself (a click-through) to download the corresponding web-pages of the advertiser (i.e., “surfing the web”). Advertisers often pay a fee based upon how many “impressions” of the ad are published (i.e., how many users displayed the ad), or how many users actually click through to the advertiser's web-site. These primitive metrics have been shown to have little correlation with the number of customers who complete transactions, making it difficult for marketers to justify the advertising expense.

Another approach to online advertising is to offer an incentive of “free” online services, such as electronic mail (Email), for which the user “pays” by viewing a number of advertisements (banner ads) while using the free services. There can be millions of users who subscribe to such services, and it is inefficient to publish the same ads for every user, rather than sending ads to only selected sets of users who conform to a specific set of criteria. These criteria define an advertising target group known as a “demographic.” Information about users is collected in various ways, and selected advertising can then be targeted at various demographics who are more likely to respond well. In general, however, there is still little correlation between subscribing to a service and wanting to see advertising about specific new products or services. In fact, there are software products that will screen out banner ads for the user, so they never even see them, although the advertiser may still have to pay for the “impressions.”

E-mail is the most universal form of Internet communication. A recent study by Pricewaterhouse-Coopers indicates that almost 50% of all Internet users list Email as their primary reason to go online. Direct Email marketing allows an advertiser to send a message that is reviewed when the recipients choose to read it. It can be saved, stored, and referred to at a later time when the recipient has a need that fits the offer. It can be targeted—sent not just to anyone who stumbles across it, but only to those for whom it is specifically intended according to information about their preferences, lifestyle, or other demographic information. For these reasons and many more, Email is a valuable online advertising vehicle. In order to address Email to the appropriate audience, the advertisers must compile or subscribe to databases of various kinds.

Whether an online advertisement is transmitted as a banner ad or via Email, there are practical considerations regarding how much information can be sent. Many users dial into networks using low-speed transmission circuits, or they have older machines lacking the processing power or memory capacity necessary to view the more sophisticated banner advertising. In extreme cases, all useful work can grind to a halt as the frustrated user waits for a banner ad to download and display. Most advertisers would send the same banner ad or Email to all recipients, disadvantageously ignorant of the actual transmission, processing, and display capabilities of the users' PC's.

Database marketing uses a database of recipient records to determine the correct audience to receive a promotional message. Each recipient record is comprised of many fields containing the available demographic, and preference information for that recipient. The information can be periodically updated by various means. By contrast, subscription marketing (such as that used by PostMasterDirect and YesMail) relies on the information provided during a “subscription” of the recipient to a particular list of interests or to a category. Unfortunately, very little is known about the recipient, including any detailed data concerning the subscription or any subsequent change. A user is queried (and profiled) only once. Database marketing is therefore vastly superior to subscription marketing, enjoying much higher response rates and return on investment for marketers. Because audiences can quickly tire of the bombardment of advertising that is unrelated to their current interests, and these interests can change fairly quickly, advertising needs to be as specifically and accurately targeted as possible. The more pertinent data about a potential recipient, the more accurate the decision about whether to include that person in a targeted group or not.

There are different types of data sets available such as (a) the general consumer demographics including age, profession, gender, geography, income level, etc. and (b) general business demographics including SIC code, industry, employee count, credit rating, office locations, etc. However, since most services have only one type of data set or another, it is difficult to combine all available data sets in creative ways as new industries emerge, where there are no usage statistics to draw upon. Conventional marketing databases have only limited information about specialty interest groups, although new types of groups arise frequently. These factors and other disadvantages mean that Email campaigns informed by such database approaches are slow to react to changes. Users do change their interests over time, and there has been no comprehensive way to update the corresponding information in the databases, thus putting the advertisers at a disadvantage as the users continue to get annoying ads targeting interests they no longer enjoy.

The operation of large databases is also problematic. Specialized advertising information is very valuable and there is a tendency to hoard the best information. Therefore, a distribution service may have to post-process a list of user identifiers (e.g., subscriber ID) to translate them into actual, working, Email addresses that are kept in a separate, confidential database. Compilations of new lists for a specific demographic can be time-consuming as huge lists have to be sorted and compared for the desired combinations of factors. Similarly, large numbers of Emails must be created and carefully sent; in order that users do not receive multiple copies, or even the wrong advertisement. More importantly, a growing user community strenuously objects to receipt of unsolicited commercial Email, and advertisers must take the necessary steps to avoid sending to such users.

Even though the Email advertisement may have been sent to a long list of users, there is no standard mechanism to determine whether the message has been opened by the user, let alone read, unless the user personally replies or otherwise accesses the advertiser's services in an identifiable manner. Much Email could pile up and sit unread until long after a tantalizing E-coupon or other limited-time-offer has expired. The advertiser therefore over-pays to prepare and send many ineffective Emails that could be avoided if additional recipient information could be uniformly tracked.

It is also difficult for marketers to select among advertisers who each claim large numbers of “impressions” or “Email addresses” absent any objective and accurate measurement of how many users the advertisements may reach in a newly defined demographic. Similarly, few advertisers have any actual evidence that the banner ads were seen or Emails were actually delivered to the invoiced number of users, let alone which users.

### SUMMARY OF INVENTION

The present invention provides a new and useful system for recipient selection and message delivery whereby demographic information is timely updated, new database lists can be quickly generated, and Email advertisements targeted, sent, and tracked. The system also has features of scalability and fault tolerance.

A system for distribution of a targeted advertisement over a communication network to an addressable set of users according to the present invention includes a database including demographic information for a plurality of users and/or subscribers, an order processing component in communication with the database, which, upon receiving a demographic query, determines a set of users matching the demographic query from the database. An email service provider component in communication with the order processing component receives information for the set of users matching the demographic query, to send a targeted advertisement over the communication network to each user. An accounting component, in communication with the communication network, receives information regarding the users' receipt of the targeted advertisement.

An order placement interface allows an entity to provide information including a demographic query and a targeted advertisement to the system, and to provide the entity with information from the accounting component. The order placement interface accepts a demographic query from an entity, and interactively provides data regarding users who match the demographic query. A demographic query agent, in communication with the database maintains information regarding users matching demographic criteria, to provide data regarding users who match the demographic query. The demographic query agent updates the maintained information for example, by determining a number of users matching a randomly chosen demographic criteria.

According to the invention, a web server is used to interact with subscribers, Email service providers, advertising agencies, and others. A set of messaging agent processes, each having a specific role, cooperate to process advertising orders, create Email advertising messages, deliver them to Email service providers (ESP), and log the results. Other agent processes are responsible for obtaining updates of subscriber/user demographic and other response information, adding the information to the database, and managing ordering and message queues for communication among agent processes. Web-based interfaces are provided for users, advertising agencies, sales agents, ESPs and system administrators.

When an ad agency requires a demographic point for which no information has been collected, a new question can be posed to each subscriber as part of logging in or opening Email, and the subscribers' responses appropriately logged and indexed. Subscriber data is collected online using either in-house methods or partnering with Internet Service Providers (ISPs), E-mail Service Providers (ESPs), Web Site Operators (WSOs), and Opt-in Email List Owners. All subscribers typically complete an online profile questionnaire, which is then automatically entered into the system database, along with a unique subscriber identification and Email handle. Valuable information about other users (who are not necessarily subscribers) can also be collected, archived, processed for statistical information, or traded. However, non-subscribers are preferably excluded from distribution lists. All further references herein primarily pertain to users who are subscribers, and the terms will be henceforth used interchangeably.

Each time a subscriber/user logs into his or her service, the system determines if that subscriber has completed the entire set of demographic questions, or whether any new demographic questions for this user have been added since the previous user session. Unanswered questions are ranked by priority and one or more questions are formatted and presented dynamically to the subscriber. Asking new questions on a regular basis permits the system to capture user input regarding new issues. Similarly, old information about users in the database is periodically confirmed, such as whether a user continues to be interested in the same hobbies. Furthermore, in order to maintain the highest quality list of only active users, the process of validating the completion of the demographic question set is, in itself, a demographic data point indicating the activity level of the subscriber. This activity pattern is recorded and inactive users can have their records periodically removed from the database. The user response to each demographic question is logged and the databases are updated in preparation for later database queries. This ensures accurate and timely database records for each subscriber. The database records are sorted according to demographic points, and lists are cached. By periodically recompiling and sorting demographic lists, online query processing time is reduced, as further described below.

The campaign ordering database is polled for new orders from advertisers, and a pending order is queued for processing. Orders may contain a request to launch a new or perhaps expanded ad campaign. A corresponding fulfillment agent designated for the task handles all pending orders destined for subscribers at a single ESP. As described below, a database query is generated using the demographic criteria from the order, resulting in a recipient list for the ESP. Multiple messages are constructed using a specified or attached file of advertising content, the address list, and any personalization information. Messages may also contain attachments (such as audio or video clips), according to the system capabilities of the intended recipients. The completed message set is then queued for delivery to each ESP. Individual copies of the message are then generated for each recipient in the selected list and forwarded to the ESP mail server. Timely status of delivery for each recipient on the list is obtained by monitoring each ESP.

Tracking of recipient actions (e.g., open message, reply to message, use coupon in the message, click on link in message) allows a marketer to measure exact penetration of a particular ad. In an illustrative system according to the invention, the subscriber profile is continually updated in real-time to reflect responses to marketing campaigns launched by others. In addition to the conventional demographic databases, the system incorporates information regarding psychographic, and interest information obtained from subscribers and others.

In an illustrative embodiment, the act of opening the web-based mail message triggers a download of an invisible tracking image from the system server itself to the user's workstation. The act of downloading the tracking image creates a notification that this particular user has opened this particular Email message, and this event is stored in the corresponding database records. This feature permits the system to further identify active users, and to provide detailed records of ad penetration for the advertisers.

A demographic query agent (DQA) is highly optimized to perform demographic queries using pre-aggregated subscriber information in response to requests from the advertising agency interface. When a query request contains multiple demographic criteria, the DQA first finds the shortest list matching one of the selected data points in the query request and compares it with the next shortest list matching another data point, discarding any subscribers who fail to meet both desired criteria. This process continues for all criteria data points with the resulting list containing only those subscribers who met all of the demographic criteria.

Lists of demographic units are compiled prior to searching, and stored in one of several levels of high-speed cache, according to factors such as frequency of use. When a search is queried, the shortest list is selected and matched with lists reflecting the other requested demographics. For example, there may be seven million entries that are male, of which 500,000 make over $75,000, and 200,000 have shopped online in the past six months. However, there may be only 100,000 subscribers with “camping” interests. The DQA automatically selects the list of campers (the shortest list), and determines which of those have shopped online (the second shortest list), etc., until all requested demographic constraints have been satisfied. This results in the fastest compilation of a list containing only the selected demographic combination. It also permits service sales agents to instantly determine how many users meet some requested pattern, upon request of a potential customer.

The entire system can be run on a single physical machine, or, with virtually unlimited scalability, spread across multiple machines in a local area network for better performance and availability. A Master Controller (MC) Agent process runs on each server participating in the system, but only one MC is dynamically elected Primary Master Controller (PMC) for the entire system, and each of the other MCs in the system are subordinate to the PMC. A Master Controller (MC) Agent is responsible for starting and stopping other agent processes for the machine on which it is running. When a designated PMC process is stopped for any reason, one of the other MCs automatically takes over the PMC role. The system can be configured to automatically compensate for increased workloads by starting and stopping additional agents. The PMC is responsible for monitoring system condition and workload by tracking both work queue lengths and how many agents are running in the system to process the work in the queues. When the PMC detects an increased workload state, indicated by a work queue exceeding a specified queue length, it will automatically react by sending agent start requests to other MCs in the system. Each machine participating in the system is profiled with how many instances of which agents it is allowed to run, depending on its size and speed. The PMC uses this information, along with current machine state, to determine which MC, running on a particular machine, is asked to start additional agents, thus implementing effective workload balancing among all machines participating in the system. System capacity can be dynamically increased by adding a new machine to the local area network and starting a MC on it. The new MC registers its presence with the system PMC, and is immediately available for new agent start requests.

While multiple agents may be active, the PMC monitors and maintains delivery logs for each ESP in a manner that ensures completion of distribution of an Email campaign without duplication. Orders are processed in a manner that provides efficient utilization of telecommunication links with ESPs. Each ESP has different, and sometimes unique requirements for email campaign delivery. The Order Delivery Agent (ODA) component of the invention is responsible for constructing and delivering the actual email messages according to the rules established for each ESP.

For some ESP, rather then sending thousands of copies of an email, a single body of an advertisement is sent, along with a list of those users selected by the DQA whose identifier corresponds to the ESP. The ODA builds and addresses a single email containing a list of each selected subscriber's unique identifier, and transmits it to the ESP mail server. For security purposes, the ESP can use this technique to make a translation from the unique identifier of each subscriber into a valid Email address maintained only by the ESP. This permits better control of valuable Email addresses, since they are not available in the central demographic database.

In another illustrative embodiment, an advertising message sample (with any attachments) can be sent to an ESP for verification or approval prior to further distribution. Each ESP can be designated to have veto rights on all advertisement campaigns sent to their subscribers. If an ESP veto is received within a predetermined time, then the distribution within that ESP is cancelled. Otherwise, distribution automatically proceeds. In an alternative embodiment, the system can be selectively configured to automatically exclude an ESP from all or selected advertising campaigns based on campaign size or content. Each ESP has the ability to define its own list of “dirty words” that, if present in an email campaign, will exclude that ESP from the campaign.

Campaign tracking information generated from user responses can quickly become unmanageable, but according to the invention, a database of “hits” is periodically summarized on a frequent basis. Real-time statistics can then be generated and displayed or delivered to ad agencies to show how well a particular ad campaign is faring.

Other web-based interface features include provisions for ESP administrators to interact with the system for maintenance or exchange of subscriber lists and status, and interaction with advertising agencies such as sample queries, campaign status, campaign cancellation, billing status, and campaign previews.

In another feature that will provide scalability, a memory mapping of files containing pre-aggregated demographic data in the cache can be implemented such that multiple Demographic Query Agents can simultaneously share the same files. This feature will improve performance by allowing multiple query tasks to proceed without having to wait for each other to release the cached files.

E-mail solicitation is most effective when a rich combination of quality recipient data (demographics, psychographics, interests) is available to aid in audience selection. Also, it is crucial that targeted recipients have all given permission to marketers to send promotional offers. This is commonly referred to as “permission-based” direct e-mail marketing. The system tracks the messages that are opened, not just delivered, allowing highly detailed invoicing for messages that are verified as delivered. This provides the most powerful e-mail direct marketing tool available today.

The invention also addresses the need to limit the number of Emails sent to subscribers during a given period. Timing and monitoring features are adapted for enforcing such limits and for allowing ESPs to request ad campaign mailings during specific periods. Another feature permits selection of subscribers onto the lists according to whether the subscriber's weekly maximum advertising quota has been reached. Additional features permit random selection from the databases while ensuring that a particular campaign selection can be repeated, if necessary. This feature allows better real-time recovery during creation of an ad campaign list.

Other advantages of the invention are numerous. All recipients have comprehensive data profiles that are queried to ensure that messages reach the RIGHT audience. At least three distinct database segments are compiled and maintained for demographic searches: consumer data, business data, and “specialty/interest group” data. Each ESP can be configured to maintain a different set of demographic questions making up that ESP's subscriber's demographic profile. Responses to new questions are automatically added and new lists computed for that demographic. There is no special software for the recipient Email user to download and 100% compatibility is assured. Marketing messages can be personalized to the recipient and are guaranteed to be delivered to the ESP mail server regardless of equipment downtime and/or network downtime. The databases contain a self-cleaning system for constantly removing undeliverable recipients, saving wasted messages and expense. Inactive users can be detected and their records culled and set aside. Once the ad copy has been prepared with the appropriate tracking links, the system is fully automated and there is no required lead-time for creating an ad campaign, beyond normal processing time and network latency. Normal delivery of a campaign typically occurs within a few minutes of reaching the requested launch date and time.

A system in accordance with the present invention has the ability to send many different ad formats. The most simple and universally compatible format is plain text. Everyone who uses e-mail can open and read messages in this format. Of course, the text may include a clickable hyperlink or an HTML text messages. However, not all recipients have the ability to receive and read these types of messages. The system can determine the processing and system requirements of each individual recipient and deliver the appropriate format to each subscriber. This process is automatic and does not require recipients to download additional software, plug-ins, or extensions.

### BRIEF DESCRIPTION OF THE FIGURES

These and other features of the present invention will be better understood in view of the following detailed description taken in conjunction with the drawings, in which:

FIG. 1 is a block diagram of a system according to the present invention;

FIG. 2 is a more detailed block diagram of an illustrative embodiment of the present invention;

FIG. 3 is a block diagram of an implementation of the illustrative embodiment of FIG. 2;

FIG. 4 is a flow chart of a how a database is updated for new subscriber demographic information; and

FIG. 5 is a block diagram of how database queries are processed according to one embodiment of the present invention.

### DETAILED DESCRIPTION

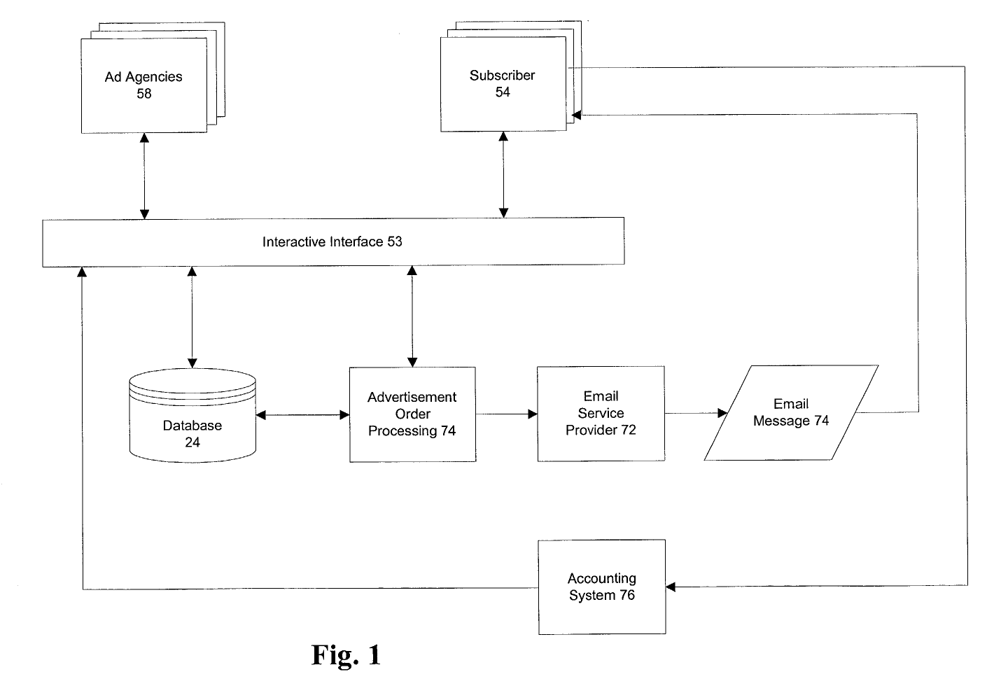

A system 20 according to the present invention is shown in FIG. 1. Subscribers 54 are persons who wish to receive directed email advertisements. Subscribers 54 may interact with the system 20 through an interactive interface 53, which for example is a web page with subscriber login options. The subscriber 54 can set up an account, edit their account, update their demographic answers, and make other changes and preferences. Information for the subscriber 54 is stored in a database 24. This information typically is demographic information such as age, sex, preferences etc. and is used to determine what type of directed email advertisements to send to the subscriber 54. Although shown as one database, the database 24 may be several different databases, possibly at remote locations and in different formats.

Ad Agencies 58 are entities that wish to send directed email advertisements to appropriate subscribers 54. Such ad agencies 58 also may interact with the system 20 through the interactive interface 53, for account administration, and also for submitting materials, such as ad copy, for directed email advertisements. An ad agency 58 would typically use the interface to construct a demographic query, submit the ad copy materials, and submit an order request. As will be described below, the system according to the present invention includes interactive tools to allow an ad agency 58 to request information regarding the size of a subscriber pool that meets selected demographic profile, and quickly receive the information. Once an ad agency 58 provides material and description of the target audience, the ad agency 58 can place an order for delivery of the directed email advertisement.

When an order is received, an advertisement order processing system 74 will obtain a list of the subscribers 54 stored in database 24 which meet the target audience for the directed email advertisement. This list, along with the advertising materials, is processed and an appropriate email campaign is sent to an email service provider 72 for processing. The email service provider 72 then either delivers the individual emails or resolves the subscriber's unique identifier to an actual email address and sends out the individual email messages 74. An accounting system 76 helps track receipt of the email messages 74 through various techniques, including receiving emails which bounce back as undeliverable, emails which, when opened, obtain other information from remote sources on the web, and subscribers 54 who respond to the email with requests to obtain advertised services or goods. More information on the accounting system 76 will be provided below. The accounting system 76 provides information for administration and for billing the ad agencies 58 for sending out the directed email advertisements.

An illustrative embodiment of the present invention provides a system 20 with exceptional scalability and fault tolerance features. Part of this ability is through the architecture of providing actors known as Agents, which handle various functional tasks on a processor independent basis. An illustrative embodiment of the present invention can run on a computer system with one central processor; or run on a distributed network of computers, and can be configured for different computer networks and configuration while the system is running. All communication with the database 24 is handled through stored procedures. Alternatively, the present invention can be implement in hardware or firmware, with ASICs or other processors specifically designed to perform the functions as described herein.

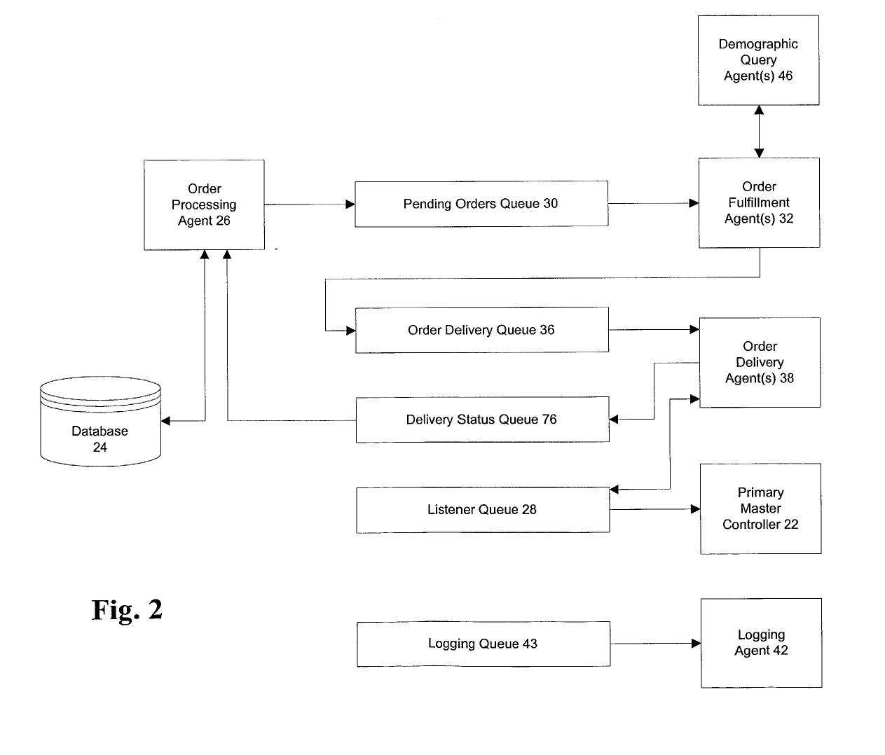

FIG. 2 provides details regarding an advertisement order processing system 74 of the present invention. The master controller 22 runs as one agent, and controls the entire system. It is responsible for all message queue negotiation as well as coordination of system resources and load balancing. The function of coordinating queue negotiation is done through a “listener queue” 28 where all other messaging agents make requests and receive their queue designations. The master controller 22 is also responsible for starting additional instances of other agents including the Order Fulfillment Agent 32s to adjust for increased workload, and stopping other Agents when they are no longer needed in an effort to provide load balancing of system resources.

The Order Processing Agent (OPA) 26 checks the database 24 for directed email advertisements orders and posts a pending orders message to the pending orders queue 30. The OPA is responsible for periodically polling the database 24, checking for orders that are ready to be processed. If there is an order waiting to be processed, a notification message is placed into the pending orders queue 30. All Order Fulfillment Agents (OFA) 32 in the system monitor the pending orders queue 30 and are assigned work on a first-come-first-served basis. The OFA 32 is responsible for fulfillment of a single order to a single email service provider (ESP) 72 (not shown). It does this by communicating with the Order Delivery Agent (ODA) 38 through an order delivery queue created for each ESP in the system. The OFA 32 sends a request to a Demographic Query Agent to return a list of the requested number of subscribers from the ESP being processed that meet the email campaign's demographic criteria. For each subscriber to receive the advertisement email, a message is constructed containing the subscriber's email address or unique identifier, and any personalization information. This message is then sent to the appropriate ESP's order delivery queue 36. The system according to the present invention is able to run any number of Order Fulfillment Agents 32 simultaneously, which allows many orders to be processed at the same time.

The Order Delivery Agent (ODA) 38 is responsible for constructing the actual directed email advertisements and delivering it to the individual subscribers 54 who are members of the email service provider 72. All ODAs 38 in the system periodically send a notification message to the Primary Master Controller (PMC) 22 requesting work assignment. For each request, the PMC 22 scans all ESP order delivery queues 36 looking for a queue with messages in it. When one is found, the requesting ODA 38 is assigned to work on that order delivery queue. An ESP's order delivery queue 36 can contain messages from many different orders directed to that ESP 72. The ODA 38 reads a message from the ESP's order delivery queue 36 and determines which advertisement email is being requested. If the ODA 38 has not encountered this advertisement email previously, it requests for the advertisement components from the database, and customizes the advertisement email according to the rules defined for the particular ESP to which it is assigned. This ESP-customized advertisement is cached by the ODA 38 as it continues to process messages from the ESP order delivery queue 36 and sends completed email to the ESP.

For each successful email sent to a subscriber, a success notification message is sent back to the Order Processing Agent 26 where the subscriber's record of activity is updated. If the email address is determined to be invalid, a “bounce” message is sent back to the Order Processing Agent (OPA) 26 and the subscriber is marked as invalid in the database. In addition, the OPA 26 periodically and automatically performs “bounce reallocation” where additional subscribers are selected to replace those that have bounced, thus ensuring that the correct number of advertisement emails ordered is actually sent. To increase performance, multiple connections can be made to the ESP's SMTP server.

A logging agent 42 keeps track of all operations in the system 20 through messages received in the logging queue 43. This provides a high level of detail regarding system operation, and fault tolerance in the form of system state. The logging agent 42 will be described in detail below.

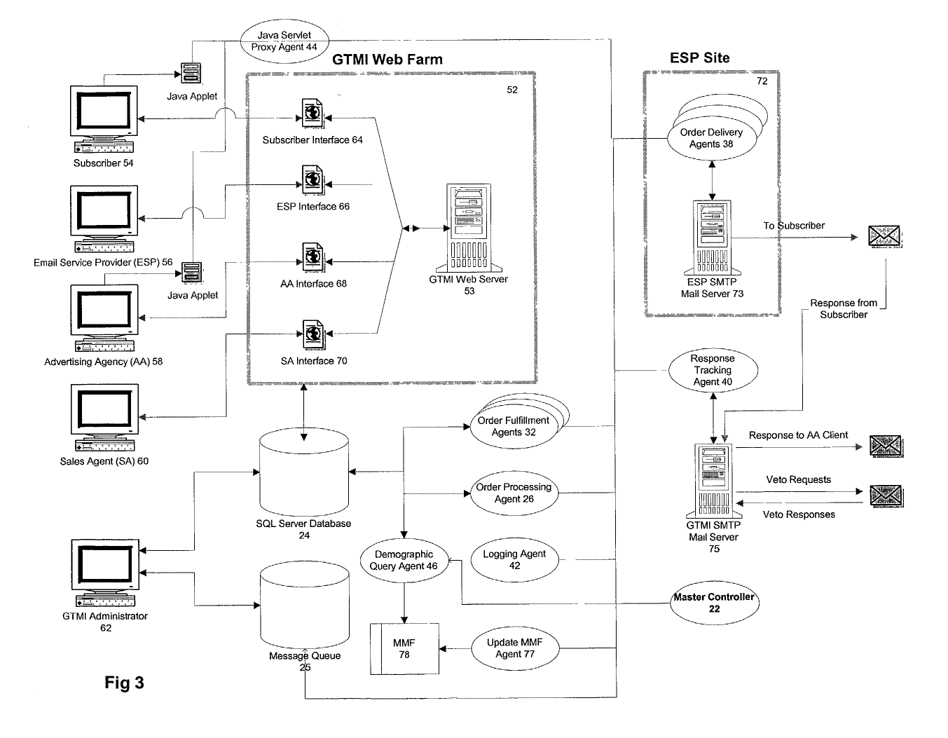

FIG. 3 shows a complete system 20 in accordance with the illustrative embodiment of FIG. 2. The system shown in FIG. 3 uses distributed computers typically running Windows® 2000 with interprocess communication provided by Microsoft Message Queuing Server and a database 24 using Microsoft SQL Server 7.0. However, the present invention may be implemented using other systems and products.

Other than the web server 53 and administrator application 62, the key components of this embodiment are built as small applications or processes that act as agents to accomplish a specific task. The agents that make up the system are described below. De-coupling system functionality using agents communicating through a message queue system has many advantages. Since the message queue 25 is enterprise wide, agents can reside on any computer on a local area network. This allows users to run these processes across many systems to provide virtually unlimited scalability as system load increases. Running multiple instances of any agent on any number of machines can further enhance load balancing.

The Master Controller (MC) Agent 22 runs as an application under Window 2000. It is responsible for all message queue 25 negotiation as well as coordination of system resources and load balancing. Each Server or Workstation, configured to run any of the messaging agents, must run a copy of the MC Agent 22. The first MC 22 to become active in the system establishes exclusive control of the “listener queue” and is designated as the Primary Master Controller (PMC) 22 responsible for monitoring and controlling the entire system. All other Master Controller instances are designated as subordinate to the PMC 22. Should the PMC 22 loose exclusive control of the “listener queue”, another MC 26 will automatically take over as PMC. A Master Controller typically does not need to communicate with the database 24. All system configuration and monitoring is done dynamically through a series of system administrator applications 62 or through a messaging system configuration utility. The function of the PMC 22 is to monitor systems operations and coordinate queue negotiation between all other messaging agents. This is done through the “listener queue” where all other messaging agents make requests to receive their queue designations. All agents in the system are required to “login” with the PMC 22 when they startup by sending a message to the “listener queue”. The PMC 22 accepts or rejects the login depending on a dynamic configuration of what agents can run on which machines in the system. This configuration can be modified while the system is running to add or remove machine resources. The PMC 22 is also responsible for starting additional instances of other agents when it detects an increase in workload, and terminating agents when they are no longer needed in an effort to provide load balancing of system resources.

The Order Processing Agent (OPA) 26 runs as an application on one machine in the system. It is the only agent for which there can be only one instance running in the entire system. Its primary responsibility is to check the database 24 for orders ready to be processed, and posting a series of pending orders messages to the pending orders queue, one for each ESP designate to participate in this order's campaign. The OPA 26 typically has no user Interface. All configuration and monitoring is done through the system administrator application 62.

An Order Fulfillment Agent (OFA) 32 runs as an application under Window 2000. It is responsible for fulfillment of a single order to a single email service provider 72. All Order Fulfillment Agents (OFA) 32 in the system monitor the pending orders queue 30 and pull pending order requests from the queue on a first-come-first-served basis. The OFA 32 is responsible for fulfillment of a single order to a single email service provider (ESP) 72 (not shown). It does this by communicating with the Order Delivery Agent (ODA) 38 through an order delivery queue created for each ESP in the system. The OFA 32 sends a request to a Demographic Query Agent to return a list of the requested number of subscribers from the ESP being processed that meet the email campaign's demographic criteria. If there is a test account for that email service provider 72 in the database, it is added to the list. For each subscriber to receive the advertisement email, a message is constructed containing the subscriber's email address or unique identifier, and any personalization information. This message is then sent to the appropriate ESP's order delivery queue 36. An OFA 32 typically has no user Interface. All configuration and monitoring is done through the system administrator application 62. The order fulfillment agent 32 makes extensive use of the database 24. All database interactions are handled by stored procedures except the demographic query. The demographic query is generated dynamically and is not precompiled.

The Order Delivery Agent (ODA) 38 runs as an application on a Windows 2000 machine. It is responsible for constructing the actual directed email advertisements and delivering it to the individual subscribers 54 who are members of the email service provider 72. All ODAs 38 in the system periodically send a notification message to the Primary Master Controller (PMC) 22 requesting work assignment. For each request, the PMC 22 scans all ESP order delivery queues looking for a queue with messages in it. When one is found, the requesting ODA 38 is assigned to work on that order delivery queue. An ESP's order delivery queue 36 can contain messages from many different orders directed to that ESP 72. The ODA 38 reads a message from the ESP's order delivery queue 36 and determines which advertisement email is being requested. If the ODA 38 has not encountered this advertisement email previously, it requests for the advertisement components from the database, and customizes the advertisement email according to the rules defined for the particular ESP to which it is assigned. This ESP-customized advertisement is cached by the ODA 38 as it continues to process messages from the ESP order delivery queue 36 and sends completed email to the ESP 72.

For each successful email sent to a subscriber, a success notification message is sent back to the Order Processing Agent 26 where the subscriber's record of activity is updated. If the email address is determined to be invalid, a “bounce” message is sent back to the Order Processing Agent (OPA) 26 and the subscriber is marked as invalid in the database. In addition, the OPA 26 periodically and automatically performs “bounce reallocation” where additional subscribers are selected to replace those that have bounced, thus ensuring that the correct number of advertisement emails ordered is actually sent. To increase performance, multiple connections can be made to the ESP's SMTP server 73.

The Response Tracking Agent (RTA) 40 runs as an application under Windows 2000. The RTA 40 has two functions, processing email responses from ESPs and subscribers that may include bounce notifications, and processing tracking hit messages received when a subscribers opens an email advertisement and clicks on a link in the message to request more information. The RTA 40 picks up any email responses delivered to a specified email address, processes the content and, if required, forwards the response to the intended or designated recipient. It is responsible for screening all response Email handling at the service organization. Response email from a subscriber 54 is noted in the database 54 as a subscriber activity event and the email is then forwarded to a designated customer service representative for potential follow-up. Periodically, the RTA 40 will check for mail in the veto response mailbox. This response email may contain an email service provider's 72 response to a veto request. The order status is updated depending on the contents of the message, which can result in the order being approved or rejected for that ESP.

The Logging Agent 42 runs as an application under Windows 2000. The logging queue is used by all system components as a means to log information. All agents in the system submit constant status messages to the logging queue detailing all aspects of their operation and progress. The Logging Agent 42 is responsible for reading messages from the logging queue, and writing significant events to the database 54 for further analysis. The logging agent 42 has a user interface that displays the status messages as they are received.

The Proxy Agent 44 runs as a DLL providing system interface services to a Java servlet servicing the Web front end interface components. It is responsible for marshaling data between the other agents in the system, and the interface on the subscriber 54 and ad agency 58 demographic query pages. The Proxy Agent 44 has no user Interface. All configuration and monitoring will be done through the system administrator application 62. The Proxy Agent 44 receives an request for service whenever a remote Java applet, running on a subscriber or ad agency's machine, requests UI (user interface) information. The Proxy Agent 44 translates the Java applet request into the appropriate internal message queue message, forwards the message to the appropriate agent, waits for the response message if appropriate, and then returns the result to the Java applet. A user interface request would result in a reply data stream that is customize for the Java applet based on the type of request, the ad agency 58 or Subscriber/email service provider 72 involved, and would completely define the user interface 68, 70 including any applicable edit rules. This data is then sent as an XML document to the Java applet.

A Demographic Query Agent (DQA) 46 runs as an application under Windows 2000. A DQA 46 is responsible for performing demographic queries in response to requests from the ad agency interface 68 and Order Processing. Prior systems suffer from poor database performance because of the complicated nature of demographic queries. This query process is further complicated because of the use of dynamic queries to support each email service provider 72. Using a separate agent to perform these queries gives much greater control in the processing. The DQA 46 typically has no user interface. All configuration and monitoring is done through the system administrator application 62.

A DQA 46 is activated whenever another process requests a demographic query. Rather than query the demographic database directly, a DQA 46 will utilize pre-aggregated result sets to resolve the requested query. These pre-aggregated result sets 78 are shared among all DQA's in the system, and pre-loaded into each DQA's address space using memory file mapping techniques. The creation and maintenance of these memory mapped files if the responsibility of the UpdateMMF Agent 77 (described below). To resolve a demographic query, the DQA 46 first determines which of the data points in the query has the smallest number of subscribers. The final result set cannot be larger than this set. The DQA 46 culls this smallest list to remove any ineligible subscribers and the compares the remaining list to the next smallest list of another data point in the query. A subscriber must be on both lists or it is removed from the smallest list. Each data point of the query is processed until the final list of eligible subscribers meeting all criteria of the query is obtained. For a demographic query request from the ad agency interface 68, the resulting count of the final result set is returned. For Order Processing, a message is created for each subscriber on the resulting list and sent back to the requestor.

This technique of pre-aggregating result sets for demographic query resolution results in order of magnitude decreases in query response time. An average demographic query against the database can take 20 minutes or more to resolve without resorting to expensive hardware solutions. By pre-aggregating result sets, a typical demographic query can be resolved in seconds using standard off-the-shelf computing hardware. Because the data in the preaggregated result sets is not absolutely fresh from the database (“realtime”), it has been labeled a “Virtual Realtime Result”.

An UpdateMMF Agent (77) runs as an application under Windows 2000. It has one function: update the pre-aggregated memory mapped files 78 with current data. Periodically, the UpdateMMF Agent 77 will query the database for all possible answers to a particular demographic question, and then query the database to obtain a list of all subscribers that answered that demographic question in with each of the answers. Each list of subscribers resulting from a question and answer pair is then used to create or update the pre-aggregated memory mapped file 78 used by all Demographic Query Agents 46.

The subscriber interface 64 is written in ASP for browser compatibility. The subscriber interface includes five viewable pages: the login page, three demographic entry pages, and a demographic viewing page.

Since the System is capable of using different demographics for each Subscriber 54, based on their email service provider 72, the subscriber demographic form can be written as a Java Applet that will handle all UI presentation and edit rules.

The email service provider interface 66 typically is a Web GUI based on ASP technology. It allows the email service provider 72 to access information and edit its account on the system 20.

The sales agent interface 70 is a Web-based interface that sales agents (SA) 60 use to edit account information, view commissions and view existing accounts, etc.

The advertising agency interface (a.k.a TMDirect or TargitMail Direct) 68 is implemented as a Web-based application. It allows ad agencies 58 or other individuals to view and process information about their accounts, test demographic queries, and set up add initiate email campaigns. Account balance information includes information such as when the last payment was made, how many orders have been sent out and what the current balance is etc. A query tool issued to generate demographic queries. A demographic query must be generated and saved before a campaign can be sent out. As in the Subscriber demographic form, a Java Applet is used to create the user interface on the fly. The Java Applet will be a tabbed window with each tab representing a subset of demographic information such as “Personal” or “Interests”. Once the ad agency 58 has created and saved a demographic query, they can press a count button to determine how many subscribers 54 match the existing profile. The ad agency 58 can initiate an order by selecting one or more ads to be sent and assigning a count to each ad selected. The Ad Agency 58 then selects at least one demographic query, designated the primary query, to be used for the campaign. A secondary and tertiary query can be specified and used, in order, only if the primary query does not result in a sufficient number of subscribers to satisfy the order. The Ad Agency 58 then enters any addition information required, such as credit card information, and set any additional options such as the send data and time, and the order “grouping”. Grouping allows the Ad Agency 58 to specify order groups consisting of the same or similar ads such that only one ad from the group will be sent to any particular subscriber. When all information is complete, the order is submitted for approval of ad content and financial arrangements. When the order is approved, the appropriate agent processes it automatically.

The administrator application 62 provides a series of sensible GUI applications required to manage ad agencies 58, (AAs), Email Providers (email service provider 72s), Sales Agents 60 (SAs), and Email Subscribers 54 that are part of system 20 of the present invention. It displays and configures the log files. It can remotely start and stop the system. It also can display and print a variety of reports, and dump accounting data into other formats including PeachTree format. The Administrator Interface is written in a variety of languages.

The database 54 is implemented in SQL Server 7.0. The database tables can be broken up into four categories; subscriber tables, Fields tables, account tables, and order processing tables.

Subscriber tables contain information about each subscriber in the system including email address or unique identifier, to which ESP they belong, personal information such as first and last name that can be used in email personalization, the count of emails sent in the current week, and activity level.

The Field tables hold bulk of the system data. All possible demographic questions are stored in an ID_FIELDS table, and each demographic question is assigned a unique FIELD_ID. Each demographic data point collected on behalf of any subscriber has a separate Field table called FIELD_#_VALUES, where # is the field ID. Each Field table has a corresponding Lookup Table containing all possible valid responses to the Field's demographic question.

Each email service provider 72 may have a different demographic form consisting of different demographic questions. The Field tables store the response values for each subscriber for this question. A subscriber 54 only has records in field tables that pertain to its email service provider 72s demographic. This data is used to check which subscribers meet a specific demographic.

Lookup tables are used for each specific demographic field. These Lookup tables have text descriptions and an associated Value ID for each different valid value in the Field table. Only the Subscriber ID and Value ID are saved in the Field tables. This design, in addition to conserving storage space and normalizing the database, provides great flexibility when expanding the demographic question set, or removing obsolete questions.

To add a new demographic question, a new entry is made to the ID_FIELDS table as well as creating a new FIELD_#_VALUES table for the new field ID and a Lookup table defining all valid answers. To remove a question, the appropriate entry in the ID_FIELDS table is deleted. The system automatically and dynamically reconfigures itself with the new information. Email service providers 72 share some of the demographic questions and sometimes will have custom demographic questions that only their subscribers will be asked. How those questions are presented is configurable by entries in the ID_FIELDS table.

Account tables store the advertising agency 58 (AA), email service provider 72 (ESP), and sales agent 60 account information. This includes profiles and financial balances for each account. Each financial transaction is stored in a transaction table. When an order detail is processed, financial transactions are stored in the account transactions table and balances are adjusted in the accounts tables.

The order processing tables are used to store advertising campaign ad content, the campaign status, advertising demographics, and response tracking data.

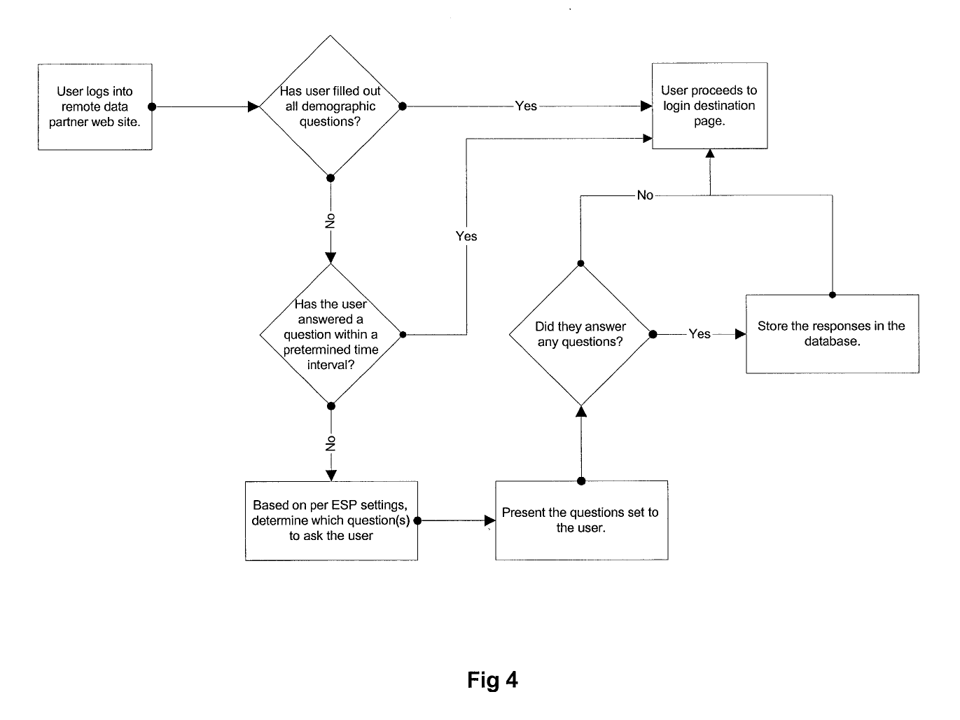

FIG. 4 illustrates a feature of the present invention termed “Dynamic Questioning” wherein demographic data can be solicited from new subscribers and new demographic questions may be added to the system at anytime. The database will automatically query subscribers 54 to obtain information based on an analysis of the question set then available and the answers previously provided by the subscriber. This makes the present invention extremely flexible and scaleable, and allows it to react to market changes very quickly. For example, an advertiser has a hot new product for which they want to send out an advertisement. They want to send the advertisement out to people who are interested in this new technology that no one has ever done before, and a demographic query or category that records interest in the new technology does not yet exist. The present invention allows the system to be easily reconfigured so that it can ask the new demographic question to all of the subscribers 54 when subscribers 54 log on to their e-mail systems. This powerful feature allows continuous interactive updating of the demographic data as new advertisement sources are identified and as subscribers 54 change their hobbies, change age group, get married, etc.

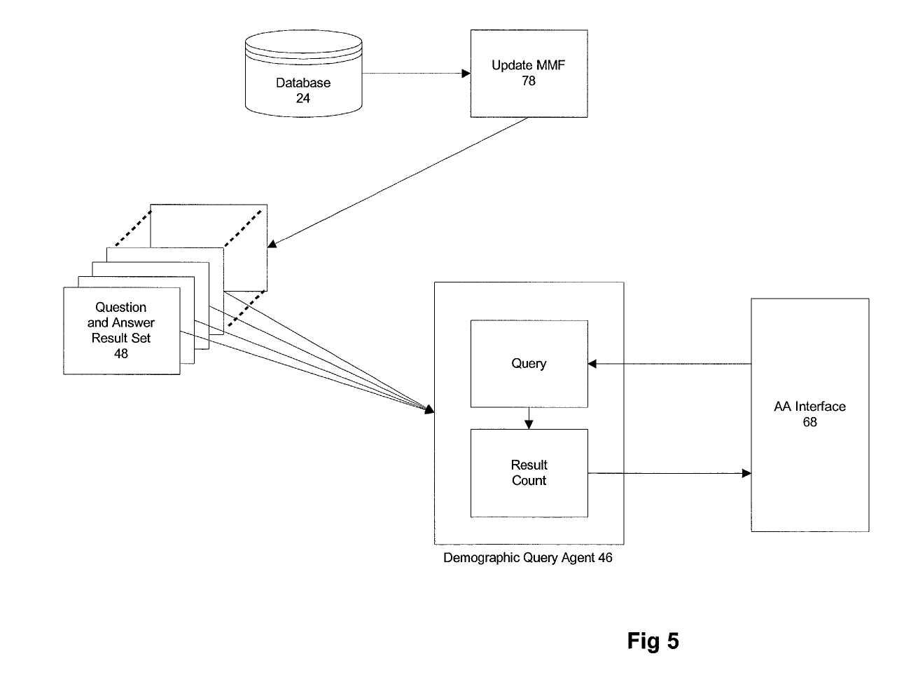

FIG. 5 illustrates another feature of the present invention wherein demographic queries can be generated for an ad agency 58 very quickly. As previously described, when an ad agency 58 is preparing a demographic query, he selects the demographics that he's interested in and he requests a count of subscribers 54 which match that demographic query. The number of people in the database 24 matching the criteria must be counted. For example, how many males over 35 make over $75,000, are interested in camping and have shopped on-line in the last six months. These are four different demographic points. In order to do an SQL query on a 20 million-entry database with four criteria like that; a system can take a half hour to 45 minutes. This is unreasonable for an online interactive query system.

The Demographic Query Agent (DQA) 46 solves this problem. Its purpose is to resolve demographic queries and return counts. It takes in a request for example those demographic with those four points and resolves it in seconds. It does this by using pre-aggregated result sets of all the question and answer pairs in the database that were prepared ahead of time and the results cached. Therefore it already has all the lists of subscribers matching the four example datapoints in memory, and in performing the comparison for demographic points, it takes the smallest list, and then removes from that list any that are not in the other lists for the other demographic points.

This is fine for databases that aren't changing. However, the database 24 is continuously being updated with changes by subscribers 54 etc. The DQA 46 uses static data to resolve demographic queries. Keeping that data fresh is the function of the UpdateMMF Agent 77. Periodically throughout the day, it will randomly select a question-answer pair and request a refresh of the result set. A random update algorithm is used to cycle through all the queries so that over time, for example over a four hour period, the UpdateMMF Agent 77 will cycle through and refresh all the data in the cache 48.

Furthermore, although particular divisions of functions are provided among the various components identified, it should be appreciated that functions attributed to one device may be beneficially incorporated into a different or separate device. Similarly, the functional steps described herein may be modified with other suitable algorithms or processes that accomplish functions similar to those of the method and apparatus described.

Although the invention is shown and described with respect to several illustrative embodiments thereof, it should be appreciated that the foregoing and various other changes, omissions, and additions in the form and detail thereof could be implemented without changing the underlying invention.

What is claimed is:

1. A system for distribution of a targeted advertisement over a communication network to an addressable set of users, said system comprising:
a database including demographic information for a plurality of users;
an order processing component in communication with said database, said order processing agent upon receiving a demographic query, determines a set of users matching said demographic query from said database;
an email service provider component in communication with said order processing component, to receive information regarding said set of users matching said demographic query, to send a targeted advertisement over said communication network to each user in said set of users;
an accounting component, in communication with said communication network, to receive information regarding users' receipt of said targeted advertisement

2. The system of claim 1 further including:
an order placement interface, to allow an entity to provide information including a demographic query and a targeted advertisement to said system, and to provide said entity with information from said accounting component.

3. The system of claim 2 wherein said order placement interface accepts a demographic query from an entity, and interactively provides data regarding users who match said demographic query.

4. The system of claim 3 further including a demographic query agent, in communication with said database, said demographic query agent maintaining information regarding users matching demographic criteria,- to provide said data regarding users who match said demographic query.

5. The system of claim 4 wherein said demographic query agent updates said maintained information by determining a number of users matching a randomly chosen demographic criteria.

6. The system of claim 1 wherein information regarding users' receipt of said targeted advertisement are selected from the group including undeliverable message, message which request further information over said communication network, and responses from users who respond to said targeted advertisement.

7. The system of claim 1 wherein said database can accept a new demographic category, and said system will query said users for information regarding said new demographic category, and update a user's demographic information in said database based on said user's response to said new demographic category.

8. The system of claim 4 wherein said order processing component includes:
an order fulfillment agent in communication with said demographic query agent, to receive information regarding said set of users matching said demographic query; and to provide addressing information for each user in said set of users to said email service provider component.

9. The system of claim 8 including a plurality of order fulfillment agents.

10. The system of claim 8 wherein said order fulfillment agent communicates with said email service provider component through a queue.

11. A method for distributing a targeted advertisement to a set of users meeting a defined demographic requirement, said method comprising:
obtaining demographic information for a plurality of users;
selecting a set of users who match a demographic query comprising a combination of demographic criteria, said selection based on said demographic information;
sending to each user in said set of users said targeted advertisement over a communications network; and
providing each user with a communication channel to allow each user to provide additional demographic information.

12. The method of claim 11 wherein said step of obtaining demographic information includes storing said demographic information for each user in a database in defined demographic categories, wherein new demographic categories may be added to said database.

13. The method of claim 12 further including: when a new demographic category is added to said database, querying each user to obtain additional demographic information based on said new demographic category, and storing said additional demographic information in said database.

14. The method of claim 12 further including:
analyzing said database to determine sets of users who match defined demographic criteria, and maintaining in memory information regarding said determined sets.

15. The method of claim 14 further including:
randomly selecting one of said defined demographic criteria, analyzing said database to determine an updated set of users who match said selected defined demographic criteria, and updating said information in memory regarding said updated set of users.

16. The method of claim 14 further including:
providing interactive information to entities regarding users who match a demographic query by using said information in memory regarding said determined sets.

17. The method of claim 11 further including:
receiving an indication of receipt of said targeted advertisement by said user.

18. A system for distribution of a targeted advertisement over a communication network to an addressable set of users, said system comprising:
database means for storing demographic information for a plurality of users;
order processing means for obtaining a set of users who match a demographic query;
order fulfillment means to process said set of users and preparing targeted advertisements for each user;
transmitting means for transmitting said targeted advertisement to each user in said set of users;
accounting means, for receiving information regarding users' receipt of said targeted advertisement;
database updating means, for updating said database means with new demographic information; and
control means for monitoring and controlling said system, including means for dynamically increasing and decreasing processing of said system.
